(19) United States
(12) Patent Application Publication
(10) Pub. No.: US 2026/0227305 A1
(43) Pub. Date: Aug. 6, 2026

(54) PARTICLE SIZE DISTRIBUTION MEASUREMENT DEVICE, PARTICLE DIAMETER DISTRIBUTION MEASUREMENT METHOD, AND PARTICLE DIAMETER DISTRIBUTION MEASUREMENT PROGRAM

(71) Applicant: HORIBA, Ltd., Kyoto-shi, Kyoto (JP)

(72) Inventor: Hirosuke SUGASAWA, Kyoto-shi, Kyoto (JP)

(21) Appl. No.: 19/150,808

(22) PCT Filed: Jan. 25, 2024
(86) PCT No.: PCT/JP2024/002288

§ 371 Date: Jul. 24, 2025

(30) Foreign Application Priority Data
Feb. 10, 2023 (JP) 2023-018935

(51) Int. Cl. G01N 15/0227; G01N 15/0205

(52) U.S. Cl. CPC G01N 15/0227; G01N 15/0211

(57) ABSTRACT

A particle size distribution measurement device has an imaging unit configured to image a particle in a cell, and an analysis unit configured to calculate a particle size distribution by calculating a diffusion velocity due to Brownian motion of the particle based on imaging data obtained by the imaging unit.

### TECHNICAL FIELD

The present invention relates to a particle size distribution measurement device, a particle size distribution measurement method, and a particle size distribution measurement program.

### BACKGROUND ART

As a conventional particle size distribution measurement device, there is a device using a measurement method called a particle trajectory analysis method (PTA method) as shown in Patent Literature 1.

In this measurement method, a particle size distribution is measured by calculating a diffusion velocity due to Brownian motion of particles based on imaging data obtained by imaging the particles in a cell.

In order to ensure measurement accuracy, it is desirable to obtain the imaging data while focusing on many particles, but currently, an operator manually adjusts the focus position, and this work takes time and effort.

Therefore, the present inventor has attempted to apply an existing autofocus function mounted on a camera or the like in order to provide the device with a function of automatically adjusting the focus.

As such an existing autofocus function, there is an autofocus function that quantifies the contrast of an image by first order differentiation or the like and focuses on a position where the contrast is maximum, for example.

However, since the Brownian motion of the particles is inherently discontinuous motion, in other words, a motion that cannot be differentiated at a certain timing, the particles are always flickering, and there are many cases where the operation for maximizing the contrast does not converge using the above-described existing autofocus function.

This is not limited to the contrast, and is a common issue regardless of a parameter used in autofocus. That is, since various parameters appearing in an image can change in a short time, even if measures such as shortening an imaging interval using a high-speed camera, for example, are taken, there is no guarantee that the previous imaging data and the next imaging data are similar to each other, or rather suddenly change, and the focus position is often uncertain.

As a result, even if the focus function is applied to the PTA method, the success probability is very low, and may not practically contribute to reduction of time.

### CITATION LIST

### Patent Literature

Patent Literature 1: JP 2020-204604 A

### SUMMARY OF INVENTION

### Technical Problem

Therefore, the present invention intends to solve the above-described problems at once, and a main object of the present invention is to allow the particle size distribution measurement by the PTA method to achieve adjustment of a focus position with a high success probability.

### Solution to Problem

That is, a particle size distribution measurement device according to the present invention is a particle size distribution measurement device having an imaging unit configured to image a particle in a cell, and an analysis unit configured to calculate a particle size distribution by calculating a diffusion velocity due to Brownian motion of the particle based on imaging data obtained by the imaging unit, the particle size distribution measurement device including: a data group acquisition unit configured to acquire an imaging data group including a plurality of pieces of imaging data obtained by the imaging unit at each of a plurality of focus positions in the cell; a variation value calculation unit configured to calculate a variation value of a predetermined evaluation parameter obtained from each of the plurality of pieces of imaging data included in the imaging data group; and a focus position determination unit configured to determine a measurement focus position used at a time of measurement based on the variation value corresponding to each of the plurality of focus positions.

Here, as described above, various parameters included in the imaging data can change in a short time, but the degree of temporal change should be large at the focus position out of focus and small at the focus position in focus.

In view of this, the particle size distribution measurement device according to the present invention determines the measurement focus position based on the variation value of the evaluation parameter corresponding to each of the plurality of focus positions, and in other words, the measurement focus position is determined using temporal variation, which is the essence of Brownian motion.

As a result, according to the present invention, it is possible to adjust the focus position in focus with a high success probability, and it is possible to greatly reduce the time and effort for adjusting the focus.

In the meantime, since the Brownian motion of the particles is inherently discontinuous motion, it is conceivable that the variation value is accidentally reduced even at the focus position out of focus.

Therefore, in order to prevent such a focus position from being determined as the measurement focus position, it is preferable that the focus position determination unit determines the measurement focus position from a stable range including a plurality of focus positions at which the variation value is smaller than a threshold value.

In order to bring the measurement focus position closer to the focus position, it is preferable that the focus position determination unit determines either a focus position at which the variation value is minimum in the stable range or a focus position in a central portion in the stable range to be the measurement focus position.

In order to temporally vary the value of the evaluation parameter, it is preferable that the evaluation parameter is one of a contrast of an image indicated by the imaging data, a number of particles appearing in the image, an intensity of each pixel constituting the image, and a number of pixels included in the image that exceed a predetermined intensity.

When the variation value is a value indicating a degree of temporal variation of the evaluation parameter, the measurement focus position can be determined using temporal variation, which is the essence of Brownian motion.

Here, when a distribution graph in which one axis is the value of the evaluation parameter and the other axis is the frequency has, for example, a long tail trails on a side on which values increase and outliers are likely to occur, two ways including cutting of the outliers and calculation on an assumption that there is the outliers can be considered in order to calculate the variation value. However, outlier processing of cutting the outliers greatly differs depending on samples, and may cause complication of the program.

Therefore, it is preferable that the variation value calculation unit calculates the variation value by fitting a predetermined function to a distribution graph in which one axis takes a value of the evaluation parameter and the other axis takes a frequency.

With such a configuration, even if the above-described distribution is a distribution in which outliers are likely to occur, it is possible to calculate a feasible variation value without using the outlier processing that can be complicated.

It is preferable that the variation value calculation unit fits the predetermined function to the distribution graph corresponding to the focus positions included in a search area set in a part of the cell in a depth direction.

With such a configuration, it is not necessary to move the focus position over the entire region in the depth direction of the cell, and the focus position can be adjusted in a shorter time.

In the meantime, in the measurement by the PTA method, there is a case where an operation including measuring the particle size distribution, thereafter stirring the particles in the cell or changing the imaging position, and thereafter measuring the particle size distribution again.

In this case, while it is considered that the focus is currently not largely deviated after stirring and the measurement is continued without changing the focus position before stirring, it is preferable to readjust the focus position after stirring in order to further improve the measurement accuracy.

However, it takes a lot of time and effort to manually adjust the focus every time stirring is performed.

Therefore, if the particle size distribution measurement device further includes a stirring unit configured to stir the particles in the cell, the action and effect of the present invention are more remarkably exhibited, and the measurement accuracy can be further improved in a short time without taking time and effort.

It is preferable to provide a focus adjustment unit configured to adjust a focus of the imaging unit to the measurement focus position.

With such a configuration, it is possible to exhibit an autofocus function of automatically focusing on the measurement focus position.

In order to automate the measurement in the configuration including the stirring unit and the focus adjustment unit described above, it is preferable that positioning of the focus of the imaging unit by the focus adjustment unit, calculation of the particle size distribution by the analysis unit, and stirring of the particles in the cell by the stirring unit are repeated.

A particle size distribution measurement method according to the present invention is a particle size distribution measurement method using a particle size distribution measurement device having an imaging unit configured to image particles in a cell, and an analysis unit configured to calculate a particle size distribution by calculating a diffusion velocity due to Brownian motion of the particles based on imaging data obtained by the imaging unit, the method including: a data group acquisition step for acquiring an imaging data group including a plurality of pieces of imaging data obtained by the imaging unit at each of a plurality of focus positions in the cell; a variation value calculation step for calculating a variation value of a predetermined evaluation parameter obtained from each of the plurality of pieces of imaging data included in the imaging data group; and a focus position determination step for determining a measurement focus position used at a time of measurement based on the variation value corresponding to each of the plurality of focus positions.

A particle size distribution measurement program according to the present invention is a particle size distribution measurement program used for a particle size distribution measurement device having an imaging unit configured to image particles in a cell, and an analysis unit configured to calculate a particle size distribution by calculating a diffusion velocity due to Brownian motion of the particles based on imaging data obtained by the imaging unit, the program causes a computer to carry out functions as: a data group acquisition unit configured to acquire an imaging data group including a plurality of pieces of imaging data obtained by the imaging unit at each of a plurality of focus positions in the cell; a variation value calculation unit configured to calculate a variation value of a predetermined evaluation parameter obtained from each of the plurality of pieces of imaging data included in the imaging data group; and a focus position determination unit configured to determine a measurement focus position used at a time of measurement based on the variation value corresponding to each of the plurality of focus positions.

With such a particle size distribution measurement method and a particle size distribution measurement program, the same operation and effect as those of the particle size distribution measurement device described above can be obtained.

### Advantageous Effects of Invention

According to the present invention described above, it is possible to allow the particle size distribution measurement by the PTA method to achieve adjustment of a focus position with a high success probability, and to greatly reduce the time and effort for the focus adjustment.

### BRIEF DESCRIPTION OF DRAWINGS

FIG. 1 is a schematic diagram showing a particle size distribution measurement device according to an embodiment of the present invention.

FIG. 2 is a functional block diagram showing functions of the information processing device according to the embodiment.

FIG. 3 is a schematic diagram for explanation of an autofocus function according to the embodiment.

FIG. 4 is an experimental result showing variations in evaluation parameters of the embodiment.

FIG. 5 is a distribution graph showing variations in the evaluation parameters according to the embodiment.

FIG. 6 is a schematic diagram showing a particle size distribution measurement device according to another embodiment.

FIG. 7 is a flowchart showing an operation of a particle size distribution measurement device according to another embodiment.

### DESCRIPTION OF EMBODIMENTS

Hereinafter, an embodiment of a particle size distribution measurement device according to the present invention will be described with reference to the drawings.

### Device Configuration

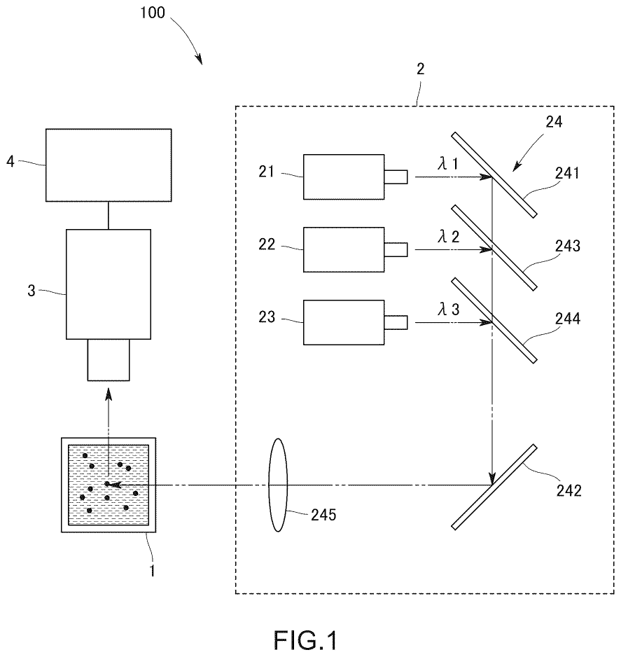

As illustrated in FIG. 1, a particle size distribution measurement device 100 according to the present embodiment includes a light irradiation unit 2 that irradiates particles in a cell 1 with light having an excitation wavelength, an imaging unit 3 that images the particles by detecting scattered light by the particles in the cell 1, and an information processing device 4 that analyzes imaging data obtained by the imaging unit 3.

The light irradiation unit 2 includes a plurality of light sources 21, 22, and 23 that emit light of different excitation wavelengths. The light sources 21, 22, and 23 are, for example, laser light sources. Here, in a case where the particles are imaged by detecting scattered light by the particle, it is necessary to emit light having an excitation wavelength suitable for a particle size. In the present embodiment, the three light sources 21, 22, and 23 are provided to correspond to particles having various particle sizes. It should be noted that one light source may emit light including three excitation wavelengths. In addition, the number of light sources may be three or more, or may be one.

The first light source 21 emits light of a predetermined first excitation wavelength λ1, the second light source 22 emits light of a predetermined second excitation wavelength λ2, and the third light source 23 emits light of a predetermined third excitation wavelength λ3 . In addition, the light emitted from each of the light sources 21, 22, and 23 is guided to the cell 1 via an irradiation optical system 24 such as reflection mirrors 241 and 242, half mirrors 243 and 244, and a condenser lens 245.

The light sources 21, 22, and 23 are controlled by a control unit (not illustrated) so as to simultaneously emit light of the respective excitation wavelengths λ1, λ2, and λ3. It should be noted that the light sources 21, 22, and 23 can also be controlled to individually emit light.

The imaging unit 3 images particles by detecting scattered light by the particles in the cell 1. In the present embodiment, the imaging unit 3 is an imaging camera such as a CCD camera, for example, and outputs image data as imaging data, for example. It should be noted that, in FIG. 1, a direction of light irradiation by the light irradiation unit 2 and a direction of imaging by the imaging unit 3 are orthogonal to each other, but the present invention is not limited to such an example.

The information processing device 4 is a computer including a CPU, a memory, a display, various input/output devices, and the like, and is connected to the imaging unit 3 in a wired or wireless manner.

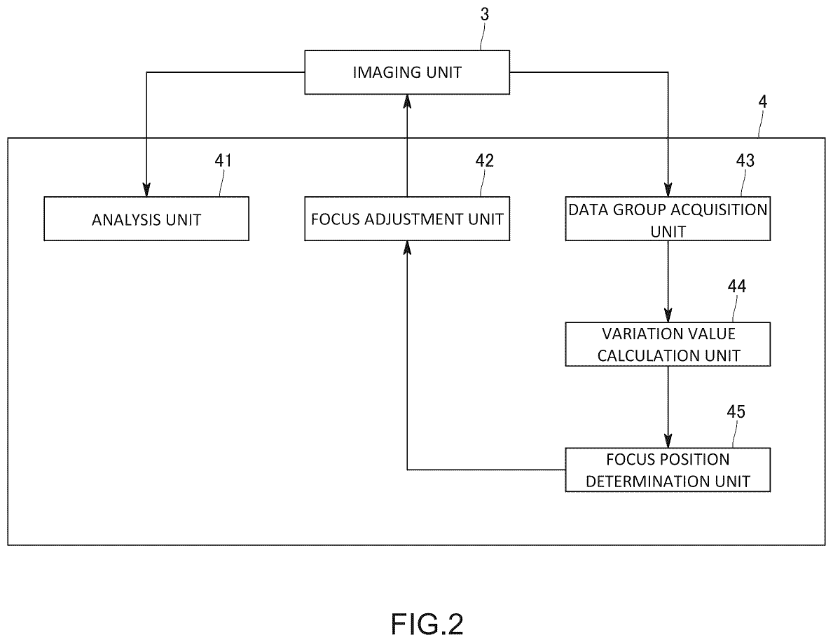

As illustrated in FIG. 2, the information processing device 4 at least functions as an analysis unit 41 by executing a particle size distribution measurement program stored in the memory.

The analysis unit 41 acquires imaging data from the imaging unit 3 and calculates a particle size distribution by a PTA method based on the imaging data. More specifically, the analysis unit 41 calculates the particle size distribution by calculating a diffusion velocity due to Brownian motion of the particles based on the imaging data.

However, the particle size distribution measurement device 100 of the present embodiment has an autofocus function of automatically adjusting the focus of the imaging unit 3 described above to the particles in the cell 1.

Specifically, as illustrated in FIG. 2, the information processing device 4 described above is configured to function as a focus adjustment unit 42, a data group acquisition unit 43, a variation value calculation unit 44, and a focus position determination unit 45.

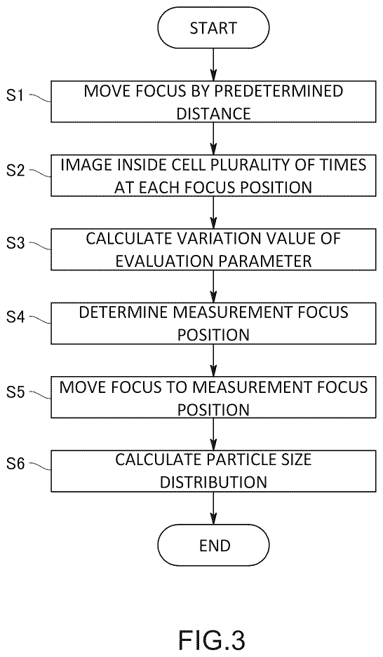

Hereinafter, an operation of the information processing device 4 will be described with reference to a flowchart shown in FIG. 3 while describing these functions.

The focus adjustment unit 42 moves the focus of the imaging unit 3 to a plurality of focus positions in the cell 1, and specifically, is configured to move the focus of the imaging unit 3 back and forth with respect to the cell 1 according to a predetermined rule.

The focus adjustment unit 42 of the present embodiment is configured to move the focus of the imaging unit 3 by a predetermined distance from the front side to the back side of the cell 1 or from the back side to the front side (S1 in FIG. 3). Although the focus adjustment unit 42 may move the focus of the imaging unit 3 over an entire region in a depth direction of the cell 1, the focus adjustment unit 42 here is configured to move the focus only to a partial region in the depth direction (hereinafter, referred to as a search area). This search area may be an unchanged range set in advance at the time of production of the device or the like, may be a range that can be changed by a user, or may be a range that is automatically changed according to a measurement condition such as a solvent in the cell.

The data group acquisition unit 43 acquires an imaging data group including a plurality of pieces of imaging data obtained by the imaging unit 3 at each of a plurality of focus positions in the cell 1.

More specifically, when the focus of the imaging unit 3 is moved by the focus adjustment unit 42, the inside of the cell 1 is imaged a plurality of times by the imaging unit 3 at each focus position of the movement destination, and the data group acquisition unit 43 acquires an imaging data group including the plurality of pieces of imaging data (S2 in FIG. 3).

However, it is not always necessary to image the inside of the cell 1 a plurality of times at each focus position, and, by imaging the inside of the cell 1 once at each focus position and moving each focus position a plurality of times, the data group acquisition unit 43 may acquire the imaging data group at each of the plurality of focus positions.

While the number of the pieces of imaging data included in the imaging data group is not particularly limited, if the number of pieces of data is too small, a success probability of the autofocus function may decrease, and if the number of pieces of data is too large, time required for autofocus increases. Therefore, it is desirable that the number of pieces of data is about several tens to several hundreds, for example.

Here, a plurality of pieces of imaging data included in a certain imaging data group are obtained by imaging the inside of the cell 1 at the same focus position, but timings (times) of imaging are different, and a difference appears in images indicated by the pieces of imaging data as the particles perform Brownian motion.

Specifically, in various parameters (hereinafter, referred to as evaluation parameter) that can be acquired from the pieces of imaging data, such as contrast of an image indicated by a corresponding piece of the imaging data, the number of particles appearing in the image, intensities of pixels constituting the image, or the number of pixels that is included in the image and whose intensity is exceeding a predetermined intensity, a difference due to a difference in imaging timing of the pieces of imaging data is generated.

Therefore, the variation value calculation unit 44 calculates a variation value of a predetermined evaluation parameter obtained from each of the plurality of pieces of imaging data constituting the imaging data group (S3 in FIG. 3).

This evaluation parameter is a parameter that can be acquired from the imaging data, and a value thereof varies with time, in other words, varies according to the imaging timing of the imaging data, and a degree of the time variation, in other words, a variation indicating a variation in the value of the evaluation parameter is a variation value.

In addition, the degree of temporal change of the evaluation parameter, that is, the variation in the evaluation parameter should be large at the focus position out of focus and small at the focus position in focus.

As described above, examples of such evaluation parameters may include various evaluation parameters, and in the present embodiment, contrast such as root mean square (RMS) contrast of an image indicated by imaging data will be described as the evaluation parameter.

In addition, the variation value may be any value as long as it becomes an index of a variation in the value of the evaluation parameter, and examples thereof include a standard deviation, a variance, a residual sum of squares, and the like. In this embodiment, the width of the distribution of the evaluation parameter will be described as the variation value (hereinafter, also referred to as a distribution width).

That is, the variation value calculation unit 44 according to the present embodiment performs image processing or image analysis on each of the plurality of pieces of imaging data constituting the imaging data group to acquire the contrast of the image as the evaluation parameter from each of the plurality of pieces of imaging data, and calculates the distribution width of the contrast as the variation value.

It should be noted that the contrast acquired by the variation value calculation unit 44 may be contrast of the entire image indicated by the imaging data, or may be contrast of a predetermined partial region in the image.

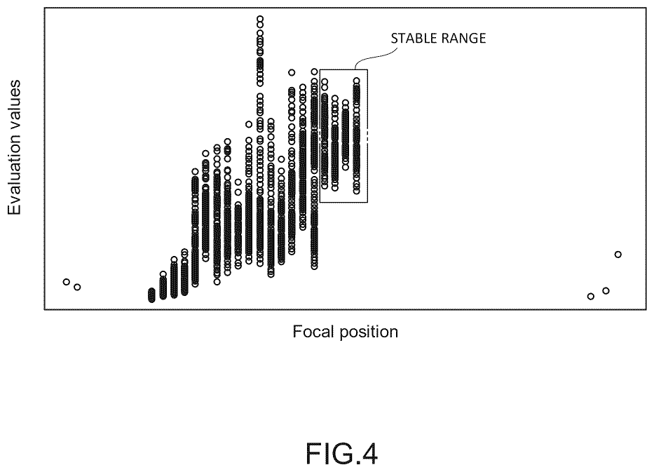

Here, a graph illustrated in FIG. 4 is such that the contrast as the evaluation parameter acquired from each of the plurality of pieces of imaging data plotted on a graph in which the horizontal axis represents the focus position and the vertical axis represents the value of the evaluation parameter. As can be seen from the graph, the values of the evaluation parameters respectively acquired from the plurality of pieces of imaging data included in a certain imaging data group vary more or less.

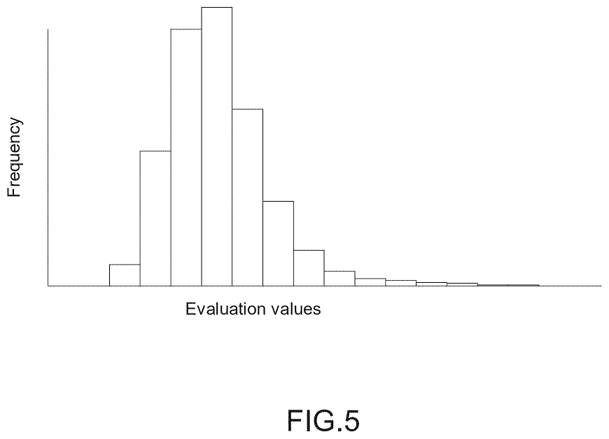

Therefore, when the values of the evaluation parameters acquired from each of the plurality of pieces of imaging data included in a certain imaging data group are plotted on a graph in which one axis is the value of the evaluation parameter and the other axis is the frequency as illustrated in FIG. 5, a spread-out distribution graph is obtained.

Therefore, the variation value calculation unit 44 of the present embodiment is configured to calculate the variation value by fitting a predetermined function to the distribution graph described above.

More specifically, examples of the predetermined function include an expression representing a probability density distribution such as a Gumble distribution and a Frechet distribution, and the variation value calculation unit 44 fits such a function to the distribution graph and obtains a distribution width from parameters included in the fitted function.

The variation value calculation unit 44 may fit a predetermined function to the distribution graphs corresponding to all the imaging data groups obtained in the search area described above, that is, distribution graphs corresponding to all the focus positions that are the movement destinations of the focus of the imaging unit 3 in the search area, or only to distribution graphs corresponding to a part of the focus positions.

Then, the variation value calculation unit 44 compares each variation value (distribution width) obtained after fitting with a threshold value, and specifies a range including a plurality of focus positions at which the variation value falls below the threshold value (hereinafter, referred to as a stable range) (see FIG. 4).

The focus position determination unit 45 determines a measurement focus position used at the time of measurement based on the variation values respectively corresponding to the plurality of focus positions (S4 in FIG. 3).

The focus position determination unit 45 determines the measurement focus position from the stable range described above, and here, one of the focus positions included in the stable range is set as the measurement focus position. A plurality of focus positions included in the stable range may be set as measurement focus positions, and these focus positions may be output in a selectable manner.

Here, the focus position determination unit 45 determines, as the measurement focus position, a focus position at which the variation value is minimum in the stable range or a focus position in a central portion of the stable range. It should be noted that the central portion of the stable range may be the center of the stable range itself, or may be a position deviated from the center to a side of the focus position at which the variation value is minimum (centroid position).

Then, the measurement focus position determined by the focus position determination unit 45 is output to the above-described focus adjustment unit 42, the focus adjustment unit 42 adjusts the focus of the imaging unit 3 to the measurement focus position before the measurement of the particle size distribution (S5 in FIG. 3), and then the analysis unit 41 calculates the particle size distribution (S6 in FIG. 3).

### Effects of Present Embodiment

According to the particle size distribution measurement device 100 of the present embodiment configured as described above, the measurement focus position is determined based on the variation value of the evaluation parameter corresponding to each of the plurality of focus positions, that is, the measurement focus position is determined using temporal variation, which is the essence of Brownian motion. Therefore, it is possible to automatically adjust the focus position in focus with a high success probability, and to reduce the time and effort for adjusting the focus greatly.

In addition, since the contrast of the image indicated by the imaging data is used as the evaluation parameter, and the standard deviation is used as the variation value, the variation value can be calculated without using complicated arithmetic processing.

In the meantime, since the Brownian motion of the particles is inherently discontinuous motion, it is conceivable that the variation value is accidentally reduced even at the focus position out of focus.

On the other hand, in the present embodiment, since the focus position determination unit 45 determines the measurement focus position from the stable range, it is possible to prevent the focus position at which the variation value accidentally decreases from being determined as the measurement focus position.

Further, since the focus position determination unit 45 determines the focus position at which the variation value is minimum in the stable range or the focus position in the central portion in the stable range to be the measurement focus position, the measurement focus position is brought closer to the focus position.

Moreover, since the variation value calculation unit 44 calculates the variation value by fitting a predetermined function to a distribution graph in which one axis takes the value of the evaluation parameter and the other axis takes the frequency, it is possible to calculate a feasible variation value without using the outlier processing even if the above-described distribution is a distribution in which outliers are likely to occur.

In addition, since the variation value calculation unit 44 fits the predetermined function to the distribution graph corresponding to the focus positions included in the search area, it is not necessary to move the focus position over the entire depth direction of the cell 1, and the focus position can be adjusted in a shorter time.

### Other Embodiment

It should be noted that the present invention is not limited to the above embodiment.

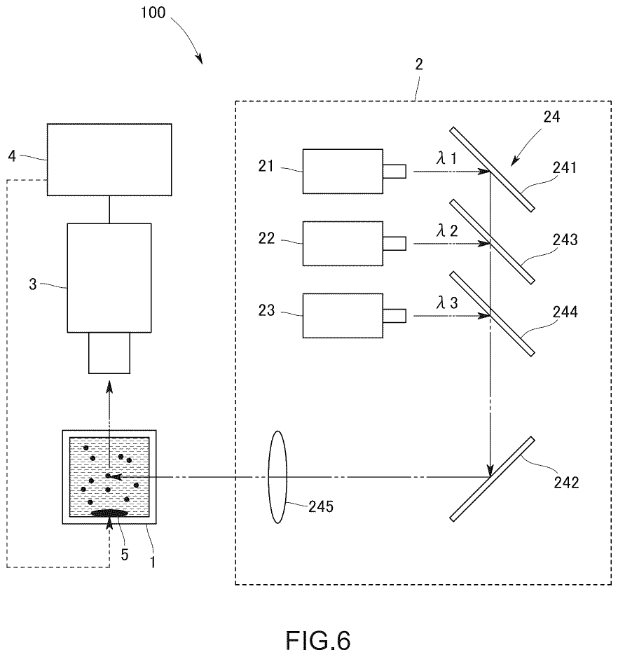

For example, as shown in FIG. 6, the particle size distribution measurement device 100 may further include a stirring unit 5 that stirs the particles in the cell 1.

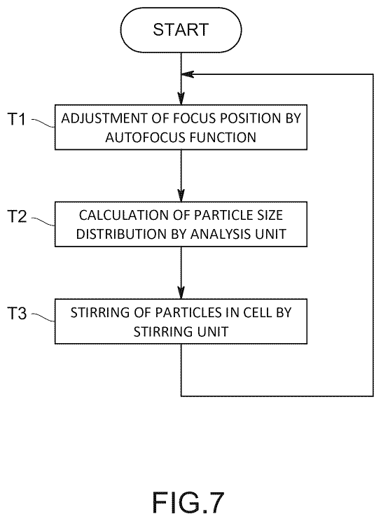

In this case, as illustrated in FIG. 7, the information processing device 4 may include a control unit that repeats adjustment of focus position of the imaging unit 3 by the autofocus function (T1), calculation of the particle size distribution by the analysis unit 41 (T2), and stirring of the particles in the cell 1 by the stirring unit 5 a plurality of times (T3).

With such a configuration, in the measurement by the PTA method, the number of times of measurement can be increased (that is, the number of particles to be measured can be increased), and the focus of the imaging unit 3 can be automatically adjusted every time the stirring is performed. Therefore, it is possible to further improve the measurement accuracy in a short time without taking time and effort.

Further, the evaluation parameter is not limited to the contrast, and may be the number of particles appearing in the image indicated by the imaging data, the intensity of each of the pixels constituting the image, or the like.

The variation value is not limited to the standard deviation, and may be a variance, a residual sum of squares, or the like.

Further, the particle size distribution measurement device 100 may be configured such that the focus of the imaging unit 3 can be manually changed, in order to finely adjust the focus position after completion of the autofocus operation, for example.

Examples of an embodiment in this case include a mode in which a focus position change button, for example, is displayed on a display or the like, and the focus of the imaging unit 3 can be manually changed by operating this button.

Moreover, the particle size distribution measurement device 100 according to the present invention does not necessarily have an autofocus function by the focus adjustment unit 42, and an operator may manually focus on the measurement focus position determined by the focus position determination unit 45.

In addition, the present invention is not limited to the above embodiments, and it should be appreciated that various modifications can be made without departing from the gist of the present invention.

### INDUSTRIAL APPLICABILITY

According to the present invention described above, it is possible to allow the particle size distribution measurement by the PTA method to achieve adjustment of a focus position automatically with a high success probability.

### REFERENCE SIGNS LIST

100 particle size distribution measurement device
1 cell
2 light irradiation unit
3 imaging unit
4 information processing device
41 analysis unit
42 focus adjustment unit
43 data group acquisition unit
44 variation value calculation unit
45 focus position determination unit

1. A particle size distribution measurement device having an imaging unit configured to image particles in a cell, and an analysis unit configured to calculate a particle size distribution by calculating a diffusion velocity due to Brownian motion of the particles based on imaging data obtained by the imaging unit, the particle size distribution measurement device comprising:
a data group acquisition unit configured to acquire an imaging data group including a plurality of pieces of imaging data obtained by the imaging unit at each of a plurality of focus positions in the cell;
a variation value calculation unit configured to calculate a variation value of a predetermined evaluation parameter obtained from each of the plurality of pieces of imaging data included in the imaging data group; and
a focus position determination unit configured to determine a measurement focus position used at a time of measurement based on the variation value corresponding to each of the plurality of focus positions.

2. The particle size distribution measurement device according to claim 1, wherein the focus position determination unit determines the measurement focus position from a stable range including a plurality of focus positions at which the variation value is smaller than a threshold value.

3. The particle size distribution measurement device according to claim 2, wherein the focus position determination unit determines either a focus position at which the variation value is minimum in the stable range or a focus position in a central portion in the stable range to be the measurement focus position.

4. The particle size distribution measurement device according to claim 1, wherein the evaluation parameter is one of a contrast of an image indicated by the imaging data, a number of particles appearing in the image, an intensity of each pixel constituting the image, and a number of pixels included in the image that exceed a predetermined intensity.

5. The particle size distribution measurement device according to claim 1, wherein the variation value is a value indicating a degree of temporal variation of the evaluation parameter.

6. The particle size distribution measurement device according to claim 1, wherein the variation value calculation unit calculates the variation value by fitting a predetermined function to a distribution graph in which one axis takes a value of the evaluation parameter and the other axis takes a frequency.

7. The particle size distribution measurement device according to claim 6, wherein the variation value calculation unit fits the predetermined function to the distribution graph corresponding to the focus positions included in a search area set in a part of the cell in a depth direction.

8. The particle size distribution measurement device according to claim 1, further comprising: a stirring unit configured to stir the particles in the cell.

9. The particle size distribution measurement device according to claim 1, further comprising: a focus adjustment unit configured to adjust a focus of the imaging unit to the measurement focus position.

10. The particle size distribution measurement device according to claim 8, wherein
further comprising: a focus adjustment unit configured to adjust a focus of the imaging unit to the measurement focus position, and
positioning of the focus of the imaging unit by the focus adjustment unit, calculation of the particle size distribution by the analysis unit, and stirring of the particles in the cell by the stirring unit are repeated.

11. A particle size distribution measurement method using a particle size distribution measurement device having an imaging unit configured to image particles in a cell, and an analysis unit configured to calculate a particle size distribution by calculating a diffusion velocity due to Brownian motion of the particles based on imaging data obtained by the imaging unit, the method comprising:
a data group acquisition step for acquiring an imaging data group including a plurality of pieces of imaging data obtained by the imaging unit at each of a plurality of focus positions in the cell;
a variation value calculation step for calculating a variation value of a predetermined evaluation parameter obtained from each of the plurality of pieces of imaging data included in the imaging data group; and
a focus position determination step for determining a measurement focus position used at a time of measurement based on the variation value corresponding to each of the plurality of focus positions.

12. A non-transitory computer readable medium storing a particle size distribution measurement program used for a particle size distribution measurement device having an imaging unit configured to image particles in a cell, and an analysis unit configured to calculate a particle size distribution by calculating a diffusion velocity due to Brownian motion of the particles based on imaging data obtained by the imaging unit, wherein the program causes a computer to carry out functions as:
a data group acquisition unit configured to acquire an imaging data group including a plurality of pieces of imaging data obtained by the imaging unit at each of a plurality of focus positions in the cell;
a variation value calculation unit configured to calculate a variation value of a predetermined evaluation parameter obtained from each of the plurality of pieces of imaging data included in the imaging data group; and
a focus position determination unit configured to determine a measurement focus position used at a time of measurement based on the variation value corresponding to each of the plurality of focus positions.
